(19) United States
(12) Patent Application Publication
(10) Pub. No.: US 2006/0165505 A1
(43) Pub. Date: Jul. 27, 2006

(54) Blind-setting coring rivet assembly

(76) Inventor: A. L. Pepper Aasgaard, Omaha, NE (US)

Correspondence Address: SUITER WEST SWANTZ PC LLO, 14301 FNB PARKWAY, SUITE 220, OMAHA, NE, 68154, US

(21) Appl. No.: 11/387,574

(22) Filed: Mar. 22, 2006

Related U.S. Application Data
(63) Continuation of application No. 10/839,633, filed on May 5, 2004, now abandoned.
(60) Provisional application No. 60/468,188, filed on May 5, 2003.

(51) Int. Cl. F16B 19/08

(52) U.S. Cl. 411/29

(57) ABSTRACT

A blind setting rivet assembly capable of permanently fastening sheet metal work pieces or the like together comprises a rivet body having a hollow tubular sleeve and an enlarged flattened head. The rivet body surrounds a mandrel that may have a weakened area to allow detachment of the mandrel shaft following application of sufficient axial force to the shank. This application of force sets the rivet by causing a tapered shoulder section of the mandrel to deform the rivet sleeve. The mandrel shank is terminated in a coring head that cores an aperture in the workpieces through which the rivet sleeve passes. The mandrel shank includes a weakened area of reduced diameter adjacent to the screw tip that allows detachment of shaft following application of sufficient axial force to the shank. This application of force causes the tapered shoulder section of the screw tip to compress and deform the rivet sleeve setting the rivet. The rivet assembly may be self polishing and self tapping and may also provide a hollow cylindrical threaded bolt head onto which a nut may be affixed to provide a means to removably attach other components.

### CROSS-REFERENCE TO RELATED APPLICATIONS

The present application is a continuation of U.S. patent application Ser. No. 10/839,633, filed May 5, 2004, which claims the benefit under 35 U.S.C. § 119(e) of U.S. Provisional Application No. 60/468,188, filed May 5, 2003. U.S. patent application Ser. No. 10/839,633 and U.S. Provisional Application No. 60/468,188 are herein incorporated by reference in its entirety.

### INCORPORATION BY REFERENCE

The following related commonly owned patents and patent applications are incorporated herein by reference in their entirety:

| Inventor | Pat/App No. | Issue Date | Filing Date |
|---|---|---|---|
| Aasgaard | 10/719,748 | | Nov. 11, 2003 |
| Aasgaard | 10/050,084 | | Jan. 14, 2002 |
| Aasgaard | 5,741,099 | Apr. 21, 1998 | Jul. 12, 1996 |
| Aasgaard | 5,762,456 | Jun. 9, 1998 | Jul. 12, 1996 |
| Aasgaard | 5,915,901 | Jun. 29, 1999 | Oct. 27, 1997 |

### FIELD OF THE INVENTION

The present invention generally relates to the field of fasteners such as rivets and the like, and more particularly to a rivet assembly having a blind-setting coring head.

### BACKGROUND OF THE INVENTION

Blind setting rivets are typically used to fasten sheet metal work pieces, or the like, together when access is available to only one side of the work pieces. However, application of blind setting rivets may at times be cumbersome. For example, in many applications, special jigs must be used to maintain exact alignment of the work pieces from the time the hole is drilled until the rivet can be applied.

Because of these and other limitations, self-drilling blind setting rivets were developed. These rivets employ specialized drill heads which may be difficult to manufacture and are thus prohibitively expensive for many applications. Further, such rivets may leave a burr on the outer layer of the work piece materials. This burr may prevent proper seating of the rivet and may cause fractures in work pieces as it is applied, resulting in a weak joint. Known to the art are self-drilling rivets having deburring ears to remove burrs during the drilling operation. However, the drill bit of such rivets removes work piece material to create a hole for the rivet shank. This removed material may fall within an enclosed area creating a possible nuisance or hazard.

Typical drill bits have spirals designed to help the metal edges cut and spiral the shrapnel out. In a typical self-drilling rivet the spirals are designed to help the cut metal edges to create shrapnel which requires that high torque be placed on the mandrel of the rivet assembly. Alternatively, U.S. Pat. No. 5,915,901 describes the use of the excurvations formed during application to increase application strength. However, in some applications, a larger, polished aperture is desirable. Consequently, it would be advantageous to provide a blind setting rivet that would be capable of self-tapping and coring an aperture instead of only self drilling (using a drill bit) or only self-tapping (using a screw tip). Such a self-tapping, coring rivet should retain material removed from the workpiece and would leave a clean, polished aperture.

### SUMMARY OF THE INVENTION

Accordingly, the present invention is directed to a self-tapping and blind setting coring rivet assembly. In basic embodiments, the rivet assembly is suitable for permanently fastening two or more workpieces, or the like, together. In other embodiments, the rivet assembly may further include a threaded bolt head onto which a nut may be affixed for removably attaching objects or components to one or more workpieces.

In exemplary embodiments of the invention, the blind setting coring rivet assembly comprises a rivet body having a hollow tubular sleeve and a generally flattened, enlarged head. The rivet body surrounds a mandrel comprising a coring tip and a shank having a weakened area for allowing detachment of the shaft from the coring tip following application of sufficient axial force to the shank. This application of force sets the rivet by causing a tapered shoulder section joining the coring tip and the shank of the mandrel to deform the rivet sleeve. The coring tip, which in embodiments of the invention may be self-tapping, cores an aperture in the work piece(s) through which the rivet sleeve passes, retaining material cored from the workpiece(s) within the coring tip. The coring tip includes a serrated leading edge having one or more cutting teeth and may further include a generally longitudinally formed groove providing polishing edges that shave or carve small amounts of work piece material from the cored aperture for polishing the aperture.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a side elevational view illustrating a self-tapping, blind-setting coring rivet assembly having a coring head in accordance with an exemplary embodiment of the present invention;

FIG. 2 is a partial cross-sectional side elevational view illustrating the rivet assembly shown in FIG. 1;

FIG. 3 is a side elevational view illustrating the mandrel of the rivet assembly shown in FIG. 1;

FIGS. 4 and 5 are end elevational and side elevational views, respectively, of the coring head of the rivet assembly shown in FIG. 1;

FIGS. 6 and 7 are end elevational and side elevational views, respectively, of a coring head in accordance with an alternative exemplary embodiment of the present invention;

FIGS. 8, 9, 10, 11 and 12 are side elevational views illustrating a blind-setting, coring rivet assembly in accordance with an exemplary embodiment of the present invention being applied to a workpiece or workpieces; and

FIGS. 13, 14 and 15 are side elevational views illustrating exemplary blind-setting, coring bolt rivet assemblies in accordance with exemplary embodiments of the present invention.

### DETAILED DESCRIPTION OF THE INVENTION

Reference will now be made in detail to the presently preferred embodiments of the invention, examples of which are illustrated in the accompanying drawings.

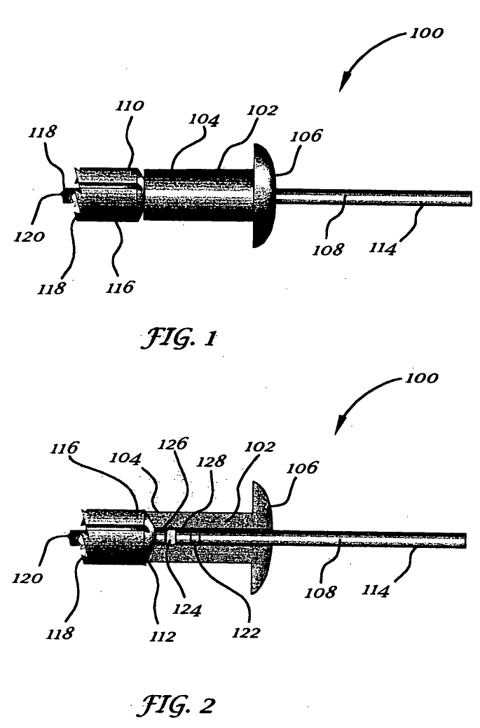

Referring generally now to FIGS. 1 through 15, self-tapping and blind setting coring rivet assemblies 100 in accordance with exemplary embodiments of the present invention are described. As shown in FIG. 1, rivet assembly 100 comprises a rivet body 102 having a hollow tubular rivet sleeve 104 and a generally flattened head 106. The rivet body 102 surrounds a mandrel 108 having a coring tip or head 110, a shoulder section 112, and a shank 114. In exemplary embodiments, the rivet body 102 may be made of steel, aluminum, plastic, composite, or other desirable rivet material. The mandrel 108 may be made of steel, aluminum, plastic, composite, or other material, which is preferably of higher tensile strength than the rivet body material.

As shown, coring head 110 is comprised of a generally barrel shaped body portion 116 having a serrated leading edge 118, and optionally a self-tapping central tip 120. During application of rivet assembly 100, coring head 110 is held substantially normal to the surface of a work piece while rotary motion is applied to shank 114. This rotary motion causes the coring head 110 to penetrate into the work piece materials, cutting or coring an aperture therein. In this manner, the cutting head 110 forms an aperture through the work piece materials.

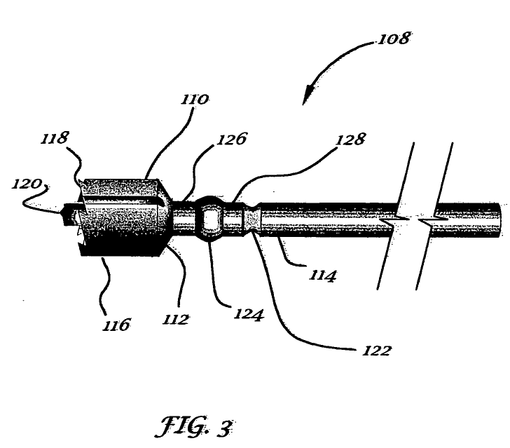

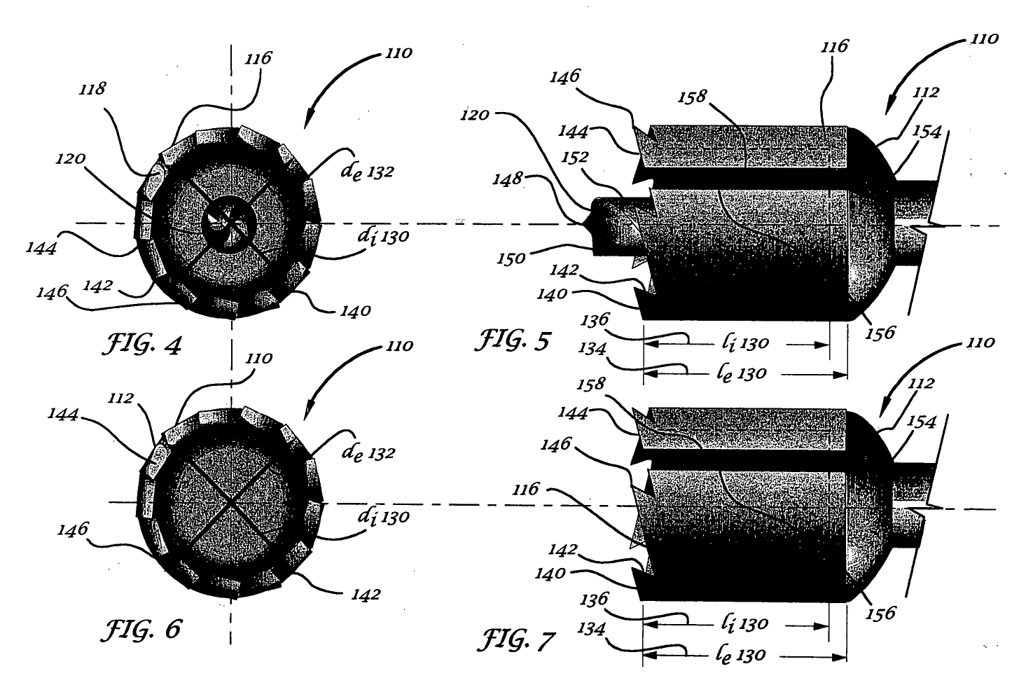

A weakened area (e.g., an area of reduced diameter, an etched area, or the like) 122 may be. formed in the mandrel shank 114 rearward from shoulder section 112. This weakened area 122 is preferably designed to fracture upon application of a predetermined tensile force to the shank 114 allowing coring head 110 and shoulder section 112 to be detached from shank 114 following completed application of the rivet assembly 100. Similarly, a restrictor or area of enlarged diameter 124 may be formed in mandrel 108 between shoulder section 112 and weakened area 122. This area of enlarged diameter 124 retains mandrel 108 within rivet body 102 until sufficient force is applied to the shank 114 during application to set the rivet body 102 and cause the area of reduced diameter 122 to fracture. In one embodiment, this enlarged area 124 also retains the cutting head 110 and shoulder section 112 within sleeve 104 following application of the rivet assembly 100 by creating an interference with the inner surface of the sleeve 104 as the sleeve 104 is deformed during application of the rivet. In embodiments of the invention, mandrel 108 may further include a grommet or like seal for providing a liquid and gas impermeable seal between the shank 114 and the rivet body 102. As shown in FIGS. 2 and 3, lengths or spaces 126 & 128 of mandrel 108 may be provided between shoulder section 112 and enlarged portion 124 and between enlarged portion 124 and weakened area 122. However, in some applications these spaces 126 & 128 may be eliminated.

In embodiments of the invention, weakened area 122 may be positioned on mandrel 108 so that a length of shank 114 remains in rivet body 102 after separation of the rear portion of the shank 114. Preferably, this length is predetermined to allow shank 114 to fracture at a point that is substantially flush with the outer surface of enlarged flattened head 106. In this manner, the remaining part of shank 114 substantially fills the hollow portion of the rivet body 102, increasing its strength.

It will be appreciated that the areas of reduced diameter 122 and enlarged diameter 124 may have different cross-sectional shapes depending upon factors such as, for example, the material from which the mandrel 108 is made, the types of work piece material(s) in which the rivet assembly 100 is being applied, the amount of fracture strength required for the area of reduced diameter 122, and the holding strength of the area of enlarged diameter 124. For instance, in FIGS. 2 and 3, the area of reduced diameter 122 and enlarged diameter 124 are shown as having generally curved cross-sectional shapes. However, in other embodiments, these areas may have a V-shape, a rectangular shape, a faceted shape, or the like.

In exemplary embodiments, the rear portion of the shank 114 may be designed for use with a specialized chuck or various types of power or hand tools to provide rotary motion and axial retraction to the mandrel 108. The shank 114 may be cylindrical in cross-section as illustrated, or alternately may have any other desired shape (e.g., square, hexagonal, octagonal, or the like) required by the rivet setting tool employed. Preferably, the outer diameter of shoulder section 112 is slightly larger than the outer diameter 132 of rivet sleeve 104 allowing the sleeve 104 to pass through the hole or aperture formed by coring head 110.

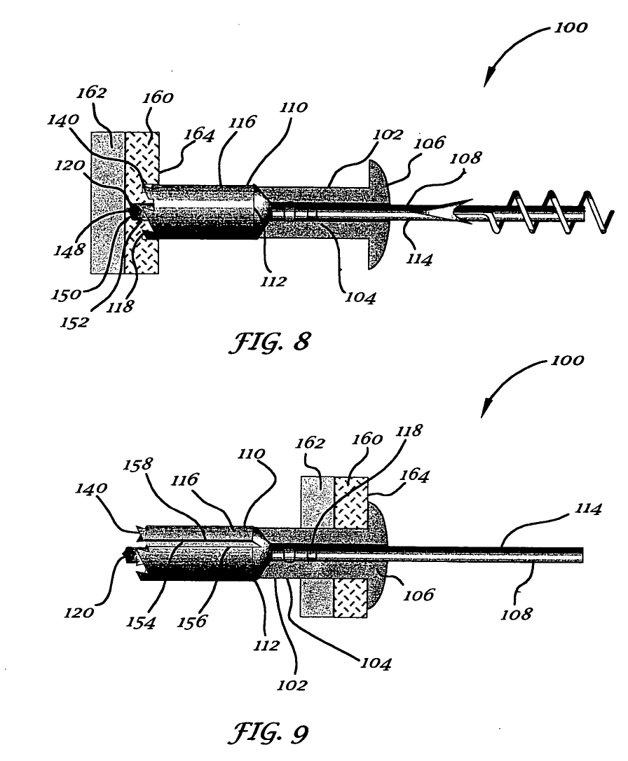

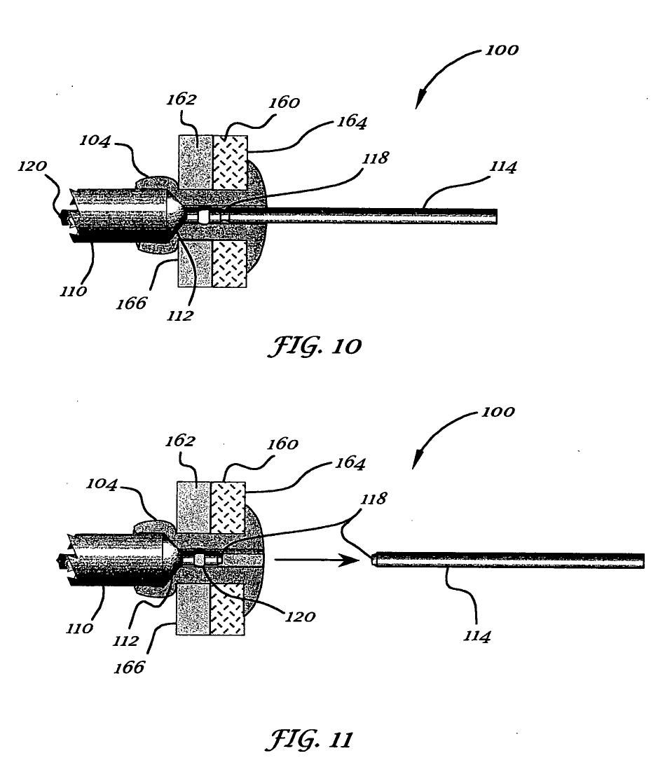

Referring now to FIGS. 4 through 7, exemplary coring heads 110 in accordance with the present invention are described. Each coring head 110 is comprised of a generally cylindrical or barrel shaped body portion 116 having an inner diameter (dᵢ) 130, an outer diameter (dₑ) 132 an external length (lₑ) 134 and an internal length or depth (lᵢ) 136 terminated in internal wall portion 138. The opposite end of body portion 116 from internal wall portion 138 is terminated in a serrated leading edge 118 comprised of a plurality of angled cutting teeth 140 arranged tangentially about the leading edge 118. In exemplary embodiments, each of the cutting teeth 140 includes a leading face 142 and a trailing face 144 meeting at an angle to form a cutting edge 146. In the embodiment illustrated, self-tapping tip 116 includes a self-tapping central tip 120 for piercing the surface of a work piece. It will be appreciated by those of skill in the art that internal wall portion 138 may be substantially flat as illustrated in FIGS. 4 and 6, or alternatively, may have other shapes without departing from the scope and intent of the present invention.

By adjusting the angle and length of leading and trailing faces 142 & 144 with respect to the longitudinal axis of the coring head 110, cutting edge 146 may be shaped so that the depth of cut during each turn of coring head 110 may be controlled, thereby controlling the torque required to insert rivet assembly 100 through a workpiece or workpieces. Moreover, by adjusting shape and orientation of the cutting edge with respect to the body portion, the type of cut made in the workpiece material may be closely controlled. For example, by angling the cutting edges 146 outward, away from the longitudinal axis of the coring head 110, material cut from the workpiece is forced outward from the cored section. Conversely, by angling the cutting edges inward, toward the longitudinal axis of the coring head 110, material cut from the workpiece is forced inward toward the cored section. It will be appreciated that teeth 140 or groups of teeth 140 may further be alternately angled inward and outward to provide additional control of the cut dynamics without departing from the scope and spirit of the present invention. Similarly, cutting edges 146 of teeth 140 may extend beyond the external diameter (dₑ) 132 of the body portion 116 so that teeth 140 take a more aggressive cut or bite from the workpiece material. Conversely, cutting edges 146 of teeth 140 may be formed to not extend beyond the diameter (dₑ) 132 of the body portion 116 in order to take a less aggressive cut or bite from the workpiece material. Again, it will be appreciated that the cutting edges 146 of teeth 140 or groups of teeth 140 may alternately extend beyond the external diameter (dₑ) 132 of the body portion 116 and remain within the external diameter (dₑ) 132 to provide an aggressive bite or cut, while forming an aperture that remains substantially smooth, requiring less polishing than would an aperture having all teeth extending beyond the external diameter (dₑ) 132. Thus, it will be appreciated that the selection precise shapes for teeth 140 will depend on factors such as the application in which rivet assembly 100 is to be used and the material properties of the work pieces in which rivet assembly 100 is to be inserted, the maximum torque available for insertion of the rivet assembly 100, and the like. Moreover, the external length (lₑ) 134 and/or internal length or depth (lᵢ) 136 of body portion 116 may be selected depending on the thickness of the workpiece or workpieces through which the rivet assembly is to be inserted.

As shown in FIGS. 4 and 5, coring head 110 may include a self-tapping central tip 120, which is preferably centered on the longitudinal axis of coring head 110, and extends from the internal wall portion 138 beyond leading edge 118. In exemplary embodiments of the invention, self-tapping central tip 120 includes an initial point 148 suitable for piercing the surface of the workpiece. In such embodiments, piercing point 148 may extend into one or more initial contact edges 150 suitable for forming a guide hole or aperture in the workpiece by puncturing, separating and then scraping or carving work piece material from the surface of the workpiece. Initial contact edges 150 may be angled and may be offset to assist in separating and tapping the work piece material(s). In this manner, self-tapping central tip 120 facilitates initial insertion (tapping) of the rivet assembly 100 allowing the rivet assembly 100 to be more easily started in the work piece. In other embodiments, as shown in FIGS. 6 and 7, coring head 110 may be fabricated without self-tapping central tip 120.

As shown, initial contact edges 150 may transition into a thread 152 extending at least substantially about self-tapping central tip 120. Preferably, as central tip 120 is inserted into a work piece and a guide hole is started by piercing point 148 and initial contact edges 150, thread 152 pull the central tip 120, and body portion 116, through the work piece material, reducing the amount of force required to tap the coring head though the workpiece. It will be appreciated that those of skill in the art may employ thread designs other than those specifically illustrated and described without departing from the scope and intent of the present invention. For example, the size and pitch of threads 152 may be varied, or the width or spacing of thread 152 may be increased or decreased.

As shown in FIGS. 4 through 7, one or more grooves 154 may be formed generally longitudinally in barrel shaped body portion 116. Each groove 154 may extend to various depths in barrel shaped body portion 116 and may have a variety of shapes depending on factors such as, for example, the material of the work piece for which the rivet assembly 100 (FIG. 1) is to be used (e.g., steel, aluminum, plastic, etc). For example, in exemplary embodiments, groove 154 may have a generally half-conical or elliptical shape extending from leading edge 118 to shoulder section 112. However, it will be appreciated that groove 154 is not limited to this shape, but may have other shapes depending the materials of the work pieces in which the rivet assembly 100 (FIG. 1) is being inserted, the size and shape of teeth 140, and the like. For example, in one embodiment, groove 154 may extend only partially from shoulder portion 112 of coring head 110 to leading edge 118 while in another embodiment groove 154 may vary in depth or width uniformly between leading edge 118 and shoulder portion 112 or may vary in depth or width in a non-uniform manner. It will be appreciated that coring head 110 may also be fabricated without groove 154, without departing from the scope and intent of the present invention.

A polishing leading edge 156 and polishing trailing edge 158 may be formed along one or more of grooves 154. Preferably, polishing leading and trailing edges 156 & 158 remove any excurvations (e.g., material bored away from work piece by coring head 110) leaving a clean, substantially burr free aperture formed in the work piece(s) through which rivet sleeve 104 (FIGS. 1 and 2) may pass. In the embodiment illustrated polishing leading and trailing edges 156 & 158 are illustrated as being straight or linear edges. However, either or both of polishing leading edge 156 and/or polishing trailing edge 158 may be curved or curvilinear without departing from the scope and intent of the present invention. In the exemplary embodiment shown, groove 154, polishing leading edge 156 and polishing trailing edge 158 may be substantially parallel to the longitudinal axis 144 of auger 110. Alternately, any or all of groove 154, polishing leading edge 156 and polishing trailing edge 158 may be angled, thereby forming an angle with respect to the longitudinal axis. Moreover, leading polishing edge 156 may extend outwardly from the longitudinal axis further than trailing polishing edge 158 depending on the application in which rivet assembly 100 is to be used, the material properties of the work pieces in which rivet assembly 100 is to be inserted, and the like.

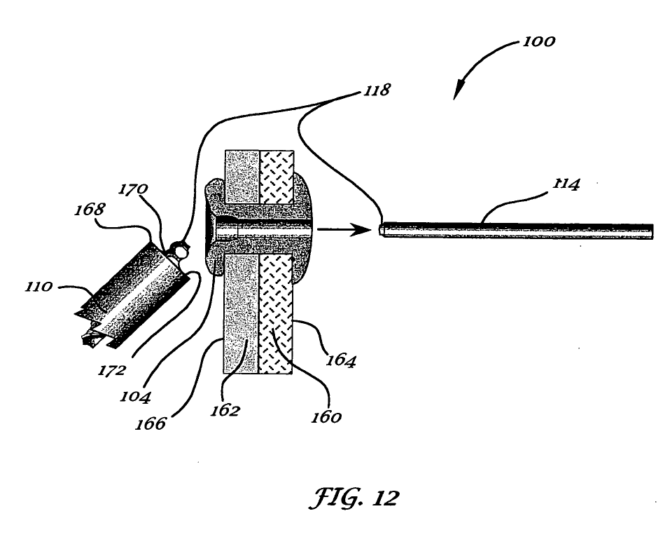

FIGS. 8 through 12 illustrate the application or insertion of a rivet assembly 100, described in connection with FIGS. 1 through 7, to join two or more workpieces (two work pieces 160 & 162 are shown). FIG. 8 depicts the rivet assembly 100 near the beginning of application. Preferably, the coring head 110 is held substantially normal to the outer work piece surface 164 while rotary motion is applied to the shank 114 of mandrel 108. For instance, as described in the discussion of FIG. 1, the rear portion of the shank 114 may be placed in a specialized chuck and power or hand tools (such as the rivet setting device described in U.S. patent application Ser. No. 10/719,748) may be used to provide rotary motion and axial retraction to the mandrel 108 (see FIG. 9, 10 and 11).

Rotary motion applied to mandrel 108 causes self-tapping central tip 120 to tap a hole or aperture in adjacent work pieces 160 & 162. As the self-tapping central tip 116 punctures, spreads and cuts the work piece materials, removed material on the inner surface 164 of the innermost work piece 160 is separated and scraped or carved away from the work piece 164. The rotary motion further engages leading edge 118 into the surface 164 of work piece 160. For example, in the embodiment illustrated, central tip 120, once tapped in workpiece 162, pulls body portion 116 toward inner surface 164 until leading edge 118 is brought into contact with surface 164. Leading edge 118 then engages the surface 164 cutting in turn though workpiece 160 and workpiece 162 so that a generally cylindrical section of each workpiece is removed. Preferably, this section is retained within the body portion 116 by central tip 120 and/or interference between the section and the inner surface of body portion 116. However, it will be appreciated that in embodiments of the invention, the generally cylindrical section cored from the workpiece may alternately be removed from body portion 116 if, for example, removal of the section is necessitated by application requirements, or the like.

FIG. 9 illustrates rivet assembly 100 following the creation of an aperture through the work piece materials (160 & 162) by the coring head 110. As body portion 116 of coring head 110 passes though the aperture formed in work pieces 160 & 162, the rotary motion applied to shank 114 further causes polishing edges 156 & 158 to shave or carve additional material, burrs caused by leading edge 118 and the like from the inner surface of the aperture, smoothing the aperture prior to insertion of rivet sleeve 104. Preferably, the outer diameter of the shoulder section 112 (see FIG. 2) is slightly larger than outer diameter of rivet sleeve 104 allowing the sleeve to pass through the aperture formed. Once the aperture is formed in work pieces 160 & 162, rivet sleeve 104 may be inserted into the aperture until enlarged flattened head 106 abuts the outer surface 164 of workpiece 160.

FIG. 10 depicts rivet assembly 100 following the application of a rearward tension force on shank 104 setting the rivet assembly 100. To set the rivet assembly 100, the rear portion of the shank 114 may be grasped by a rivet setting tool (such as the rivet setting device described in U.S. patent application Ser. No. 10/719,748), a grasping tool, or the like, and axially retracted away from surface 164 of workpiece 160. This axial retraction causes shoulder section 112 to deform rivet sleeve 114. As shoulder section 112 (and coring head 110) is drawn into rivet sleeve 104, the tapered upper face of shoulder section 112 spreads the sleeve 104 radially. This action causes the rivet sleeve 104 to be spread until it will no longer pass through the aperture created in the work pieces 160 & 162. Further, the deformed portion of rivet sleeve 104 is pulled against the surface 166 of work piece 162 tightening the rivet to the work pieces 160 & 162. Preferably, the weakened area 118 is sized to break at a predetermined tensile load greater than the tensile load required to cause deformation of hollow tubular sleeve 104, allowing the sleeve 104 to be fully deformed prior to separation of shank 114.

FIG. 11 depicts rivet assembly 100 following separation of shank 114 and setting. In the embodiment shown, coring head 110 and shoulder section 112 are retained in rivet sleeve due to interference between enlarged area 124 and the inner surface of the sleeve 104. This interference may be created by deformation of the rivet sleeve 104 during application. In embodiments of the invention, the tapered upper face of shoulder section 112 may further deform the rivet sleeve 104 to at least partially encircle the head 110 to provide additional retention of the head 110 after application of the rivet assembly 100.

FIG. 12 illustrates a rivet assembly 100 in accordance with an alternative embodiment of the present invention wherein the coring head 110 and shoulder section 112 detach from the rivet body 104 following application of the rivet assembly 100. In such embodiments, wherein polishing head 110 is allowed to drop off, the shoulder section 112 of mandrel 106 may have a face 168 comprising a tapered inner section 170 and a flat-plate outer section 172. Preferably, the tapered inner section 170 initially spreads the lower end of rivet sleeve 104. The flat-plate outer section 172 then flattens the sleeve 104 against the inner surface 166 of the workpiece 162 allowing the coring head 110 and shoulder section 112 to drop off following separation of shank 114.

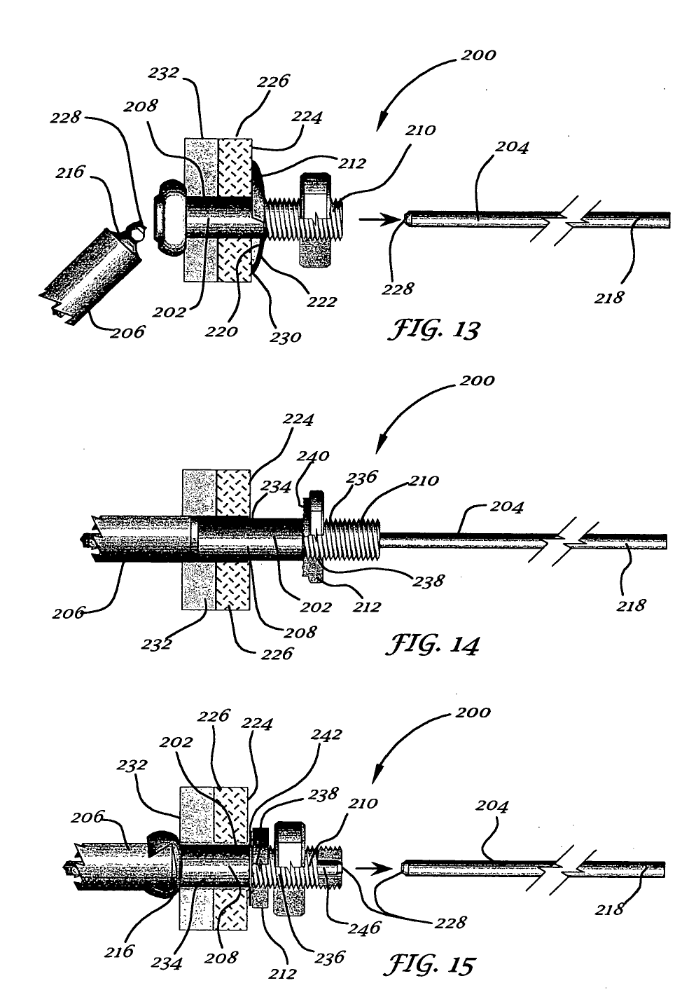

FIGS. 13 through 15 illustrate bolt rivet assemblies in accordance with exemplary embodiments of the present invention. Bolt rivet assemblies 200, like rivet assemblies 100 illustrated in FIGS. 1 through 12, comprises a hollow rivet body 202 surrounding a mandrel 204 having a coring head 206 in accordance with the present invention (e.g., employing any or all of the features of coring head 110 described in FIGS. 1 through 12). As shown, each of the rivet bodies 202 includes a hollow tubular sleeve 208 and a threaded bolt head 210 separated by an enlarged flattened head or flange 212. The rivet body 202 may be made of steel, aluminum, plastic, composite, or other desirable rivet material. The mandrel 204 may comprise coring head 206, a shoulder section 216 and a shank 218. The mandrel 204 may be made of steel, aluminum, plastic composite or other material that is preferably of higher tensile strength than the rivet body material.

FIG. 13 depicts a rivet assembly 200 comprising a rivet body 202 including an enlarged flattened head or flange 212 having a concave inner face 220 and convex outer face 222. Preferably, as rivet assembly 200 is applied, axial retraction of the mandrel 204 pulls the enlarged flattened head 212 against the surface 224 of workpiece 226, compressing and flattening the concave inner face 220. When the weakened area 228 on mandrel 204 fractures and the shank 218 is released, the concave inner face 220 attempts to retain its original shape causing the rim 230 of the inner face 220 to apply a spring-like force to surface 224. This force holds the work pieces (226 & 232) snugly between the head 212 and the deformed portion of the rivet body's sleeve 208. As a result, the head 212 may increase application strength and prevent rotation of the rivet body 202 with or without a locking washer or serrated inner surface.

As shown in FIGS. 13 through 15, the head or flange of the rivet body 202 may be part of a single piece rivet unit (e.g., as shown in FIG. 13) or it may be removable (e.g., as shown in FIGS. 14 and 15). In FIGS. 14 and 15, a rivet body 202 is depicted formed from a single tube 234 having a threaded portion 236 transitioning to the sleeve portion 208 and forming bolt head 210. In this embodiment, flattened head 212 includes a threaded aperture 238 so that the head 212 may be threaded onto threaded portion 236, and is thus removable. In exemplary embodiments, flattened head 212 of FIGS. 14 and 15 may have a six-sided or hex design similar to a standard nut, or, may alternatively be cylindrical. Additionally, as shown in FIG. 14, flattened head 212 may have serrated inner (and additionally or alternatively outer) surfaces 240 depending upon application requirements. These serrated surfaces 240 may function to increase surface friction between the rivet head 212 and the surface 226 of the work piece 226 to prevent rotation of bolt rivet assembly 200 eliminating the need for a lock washer (see FIG. 15). The serrated surfaces 240 may further function to prevent rotation of the bolt rivet assembly 200 during loosening and/or tightening of a nut onto the bolt head 210. Alternately, as shown in FIG. 15, a lock washer 242 may be utilized in place of serrated surfaces for preventing rotation of the rivet assembly 200 and removal of the head 212. Lock washer 242 may encircle rivet sleeve 204 and be trapped between the enlarged flattened head 212 and the surface 226 of the work piece 228.

Additionally, in the embodiment shown in FIG. 15, weakened area 244 is positioned on mandrel 204 so that a length 246 of shank 218 remains in rivet body 202 after separation of the rear portion of the shank 218. Preferably, length 246 is predetermined to allow shank 218 to fracture at a point that is substantially flush with the end of bolt head 210. In this manner, the length 246 substantially fills the hollow portion of the rivet body 202, increasing the strength of the rivet body 202.

FIGS. 1 through 15 illustrate coring heads 110 and 206 designed to be rotated clockwise during insertion. However, it will be appreciated by those of skill in the art that the augers illustrated herein may alternately be designed to be rotated counterclockwise during insertion without departing from the scope and intent of the present invention. Similarly, in FIGS. 13 though 15, bolt heads are shown having clockwise threads. However, bolt heads in accordance with the present invention may also be reverse threaded (i.e., may have counterclockwise threads).

It is believed that the self-polishing and tapping rivet assembly of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A rivet assembly, comprising:
a rivet body having a hollow tubular sleeve and a generally flattened head suitable for abutting the surface of a workpiece; and
a mandrel disposed in said rivet body, the mandrel including a coring head including a body portion having an inner diameter and an outer diameter and a leading edge,
wherein the leading edge of the body portion cores through the workpiece as the mandrel is rotated for creating an aperture sized for receiving the hollow tubular sleeve.

2. The rivet assembly as claimed in claim 1, wherein the leading edge comprises a plurality of cutting teeth arranged tangentially about the leading edge.

3. The rivet assembly as claimed in claim 1, wherein the body portion includes a groove formed longitudinally therein.

4. The rivet assembly as claimed in claim 3, wherein the body portion further includes at least one polishing edge formed by the groove for polishing the aperture cored in the workpiece.

5. The rivet assembly as claimed in claim 4, wherein the at least one polishing edge comprises a leading polishing edge and a trailing polishing edge formed on opposite sides of the groove.

6. The rivet assembly as claimed in claim 1, wherein the body portion further includes an internal wall portion, an internal length and an external length, and wherein the coring head further comprises a self-tapping central tip extending from the internal wall portion past the leading edge along a longitudinal axis of the coring head.

7. The rivet assembly as claimed in claim 6, wherein the self-tapping central tip comprises a point for piercing the work piece, the point transitioning into an initial contact edge for forming a guide hole in the workpiece.

8. The rivet assembly as claimed in claim 1, wherein the self-tapping central tip further comprises a thread for pulling the self-tapping central tip through the work piece.

9. The rivet assembly as claimed in claim 1, further comprising a threaded bolt head extending from the enlarged flattened head opposite the hollow tubular sleeve.

10. The rivet assembly as claimed in claim 1, wherein the mandrel further comprises a shoulder section adjacent to the coring head, the shoulder section having an outer diameter greater than the inner diameter of the hollow tubular sleeve, the shoulder section for radially compressing and spreading the hollow tubular sleeve as the mandrel is retracted, and a shank having a weakened area spaced rearward from the shoulder section and sized for allowing the coring head and shoulder section to be detached upon application of predetermined tensile force to the shank.

11. The rivet assembly as claimed in claim 10, further comprising a threaded bolt head extending from the enlarged flattened head opposite the hollow tubular sleeve, wherein the area of reduced diameter is positioned substantially flush with an end of the bolt head after the coring head and shoulder section are detached so that a length of the shank remains in the rivet body.

12. A rivet assembly, comprising:
a rivet body having a hollow tubular sleeve and a generally flattened head suitable for abutting the surface of a workpiece; and
a mandrel disposed in said rivet body, the mandrel including a coring head including
a body portion having an inner diameter and an outer diameter, a leading edge, and at least one polishing edge formed by a groove disposed longitudinally in the body portion, and
a self-tapping central tip for tapping a guide hole in the workpiece to engage the body portion with the workpiece,
wherein the leading edge of the body portion cores through the workpiece as the mandrel is rotated for creating an aperture sized for receiving the hollow tubular sleeve, the aperture being polished by the at least one polishing edge.

13. The rivet assembly as claimed in claim 12, wherein the leading edge comprises a plurality of cutting teeth arranged tangentially about the leading edge.

14. The rivet assembly as claimed in claim 13, wherein the at least one polishing edge comprises a leading polishing edge and a trailing polishing edge formed on opposite sides of the groove.

15. The rivet assembly as claimed in claim 12, wherein the body portion further includes an internal wall portion, an internal length and an external length, the self-tapping central tip extending from the internal wall portion past the leading edge along a longitudinal axis of the coring head.

16. The rivet assembly as claimed in claim 15, wherein the self-tapping central tip comprises a point for piercing the work piece, the point transitioning into an initial contact edge for forming a guide hole in the workpiece.

17. The rivet assembly as claimed in claim 16, wherein the self-tapping central tip further comprises a thread for pulling the self-tapping central tip through the work piece.

18. The rivet assembly as claimed in claim 12, further comprising a threaded bolt head extending from the enlarged flattened head opposite the hollow tubular sleeve.

19. The rivet assembly as claimed in claim 12, wherein the mandrel further comprises a shoulder section adjacent to the coring head, the shoulder section having an outer diameter greater than the inner diameter of the hollow tubular sleeve, the shoulder section for radially compressing and spreading the hollow tubular sleeve as said mandrel is retracted, and a shank having an weakened area spaced rearward from the shoulder section and sized for allowing the coring head and shoulder section to be detached upon application of predetermined tensile force to the shank.

20. The rivet assembly as claimed in claim 19, further comprising a threaded bolt head extending from the enlarged flattened head opposite the hollow tubular sleeve, wherein the area of reduced diameter is positioned substantially flush with an end of the bolt head after the auger and shoulder section are detached so that a length of the shank remains in the rivet body.
